(19) United States
(12) Patent Application Publication
(10) Pub. No.: US 2014/0113259 A1
(43) Pub. Date: Apr. 24, 2014

(54) System and Method for Reliable, Adaptive, and Objective Skills Based Testing

(71) Applicant: Trueability, Inc., San Antonio, TX (US)

(72) Inventors: Dusty Jones, Kyle, TX (US); Luke Owen, San Antonio, TX (US); Frederick Mendler, Helotes, TX (US); Marcus Robertson, San Antonio, TX (US)

(21) Appl. No.: 14/060,585

(22) Filed: Oct. 22, 2013

Related U.S. Application Data
(60) Provisional application No. 61/717,242, filed on Oct. 23, 2012.

(51) Int. Cl. G09B 7/02

(52) U.S. Cl. CPC G09B 7/02
USPC 434/219

(57) ABSTRACT

Described herein is method and system for electronic skill-based testing. A computing device, which may be a cloud server, provides a live environment to the test-taker with some issues that must be resolved. The attempts of the test-taker to resolve the issue are scored according to the efficiency and speed of the test-taker's approach, success or failure of the test-taker to resolve the issue, and by reference to the difficulty level of the task and the relative degree of achievement of other test takers.

### RELATED APPLICATION DATA

This application claims the benefit of Provisional Application No. 61/717,242, filed on Oct. 23, 2012.

### TECHNICAL FIELD

Embodiments disclosed herein relate generally to assessing technical skills, and in particular to assessment using performance-based testing.

### BACKGROUND ART

In this competitive business environment, many companies struggle to hire employees that have the requisite technical skills and training to perform technical jobs. Many businesses have found that job applicants have a wide variety of skill levels even after such applicants have been through formal schooling in relevant subjects. The skills of applicants who have graduated from college with computer science or similar degrees often vary widely from expert to incompetence when faced with technical tasks in the workplace. There is no objective and reliable measure of a person's skills based on certificates, degrees, or even prior job experiences. Employers are essentially left to gamble on whether each new hire has the requisite skills or not. This gamble can be very expensive.

Furthermore, businesses are finding it harder to justify the costly investments required to train technical employees. Setting up and running a training program can involve months and even years of paying for employees that are not contributing to the profits of the business. In addition, once an employee has been trained, they are often hired by the competitors of the company that trained them. These competitors do not shoulder the expense of training, which provides them a competitive advantage. They can offer higher salaries while still keeping costs lower by saving the expense of training.

The lack of a reliable, objective, and consistent measure of skill in hiring results in large potential costs and risk for businesses. Furthermore, the prevalence of poaching trained employees presents risk for businesses. Therefore, there is a long felt need in the art for a system and method providing reliable, adaptive, and objective skill-based testing.

### SUMMARY OF THE EMBODIMENTS

A method is disclosed for electronic skill-based testing. The method involves creating, by a computing device, a live computing environment having at least one issue, receiving, by the computing device, from the test-taker, instructions attempting to resolve the at least one issue, and calculating, by the computing device, a score evaluating the instructions.

In a related embodiment of the method, creating the live computing environment also includes providing a live computing environment that is functioning correctly, and introducing at least one issue into the live computing environment. In another related embodiment, creating the live computing environment further includes maintaining, in memory accessible to the computing device, a set of examination scenarios, each scenario comprising instructions to create a live computing environment having at least one issue, selecting a scenario from the set of examination scenarios, and executing the instructions of which the scenario is made. In an additional embodiment the scenarios are grouped by difficulty level, and selecting involves selecting a test-taker difficulty level and selecting a scenario from a group corresponding to that test-taker difficulty level. In yet another embodiment, selecting the test-taker difficulty level also involves maintaining, in memory accessible to the computing device, data reflecting past performance of the test taker, and determining, using that data, a test-taker difficulty level for the test taker. In still another embodiment, selecting additionally includes randomly selecting a scenario from the set of scenarios. Another embodiment also involves creating the live environment immediately before providing access to the test-taker.

In another related embodiment, receiving further involves recording the inputs of the test taker. Receiving includes recording the steps performed by the test taker in another embodiment. In an additional embodiment, receiving also includes recording the time spent by the test taker. In another embodiment, calculating involves analyzing the live environment and determining that the test-taker resolved the at least one issue. According to another embodiment, calculating also involves assessing the robustness of a resolution the test-taker provided for the issue. Under another embodiment, calculating also involves determining how long the live environment, as resolved by the test-taker, takes to perform a task, as a function of a parameter of the task. In yet another embodiment, calculating additionally involves ranking the score calculated for the test-taker relative to the score of at least one additional test-taker.

An additional embodiment involves maintaining, in memory accessible to the computing device, a set of model instructions that together resolve the issue, comparing the instructions entered by the test-taker to the model instructions, and increasing the score for each instruction entered by the test-taker that matches a model instruction. Another embodiment involves providing data concerning the score to the test sponsor. Yet another embodiment involves accepting, by the computing device, modifications to the score from the test-sponsor.

A system is also disclosed for electronic skill-based testing. The system includes a computing device, a live environment creator, executing on the computing device and creating a live computing environment having at least one issue, a user interface, executing on the computing device and receiving, from the test-taker, instructions attempting to resolve the issue, and a score calculator, executing on the computing device and calculating a score evaluating the instructions.

Other aspects, embodiments and features of the system and method will become apparent from the following detailed description when considered in conjunction with the accompanying figures. The accompanying figures are for schematic purposes and are not intended to be drawn to scale. In the figures, each identical or substantially similar component that is illustrated in various figures is represented by a single numeral or notation. For purposes of clarity, not every component is labeled in every figure. Nor is every component of each embodiment of the system and method shown where illustration is not necessary to allow those of ordinary skill in the art to understand the system and method.

### BRIEF DESCRIPTION OF THE DRAWINGS

The preceding summary, as well as the following detailed description of the disclosed system and method, will be better understood when read in conjunction with the attached drawings. It should be understood, however, that neither the system nor the method is limited to the precise arrangements and instrumentalities shown.

FIG. 1A is a schematic diagram depicting a computing device;

FIG. 1B is a schematic diagram depicting a web application platform;

FIG. 2 is a schematic diagram depicting an embodiment of the disclosed system; and

FIG. 3 is a flow chart illustrating one embodiment of the disclosed method.

### DETAILED DESCRIPTION OF SPECIFIC EMBODIMENTS

### Definitions

As used in this description and the accompanying claims, the following terms shall have the meanings indicated, unless the context otherwise requires.

A “computing device” is defined as including personal computers, laptops, tablets, smart phones, and any other computing device capable of supporting an application as described herein.

A device or component is “coupled” to a computing device if it is so related to that device that the product or means and the device may be operated together as one machine. In particular, a piece of electronic equipment is coupled to a computing device if it is incorporated in the computing device (e.g. a built-in camera on a smart phone), attached to the device by wires capable of propagating signals between the equipment and the device (e.g. a mouse connected to a personal computer by means of a wire plugged into one of the computer's ports), tethered to the device by wireless technology that replaces the ability of wires to propagate signals (e.g. a wireless BLUETOOTH® headset for a mobile phone), or related to the computing device by shared membership in some network consisting of wireless and wired connections between multiple machines (e.g. a printer in an office that prints documents to computers belonging to that office, no matter where they are, so long as they and the printer can connect to the internet).

“Data entry devices” is a general term for all equipment coupled to a computing device that may be used to enter data into that device. This definition includes, without limitation, keyboards, computer mice, touchscreens, digital cameras, digital video cameras, wireless antennas, Global Positioning System devices, audio input and output devices, gyroscopic orientation sensors, proximity sensors, compasses, scanners, specialized reading devices such as fingerprint or retinal scanners, and any hardware device capable of sensing electromagnetic radiation, electromagnetic fields, gravitational force, electromagnetic force, temperature, vibration, or pressure.

A computing device's “manual data entry devices” is the set of all data entry devices coupled to the computing device that permit the user to enter data into the computing device using manual manipulation. Manual entry devices include without limitation keyboards, keypads, touchscreens, track-pads, computer mice, buttons, and other similar components.

A computing device's “display” is a device coupled to the computing device, by means of which the computing device can display images. Display include without limitation monitors, screens, television devices, and projectors.

To “maintain” data in the memory of a computing device means to store that data in that memory in a form convenient for retrieval as required by the algorithm at issue, and to retrieve, update, or delete the data as needed.

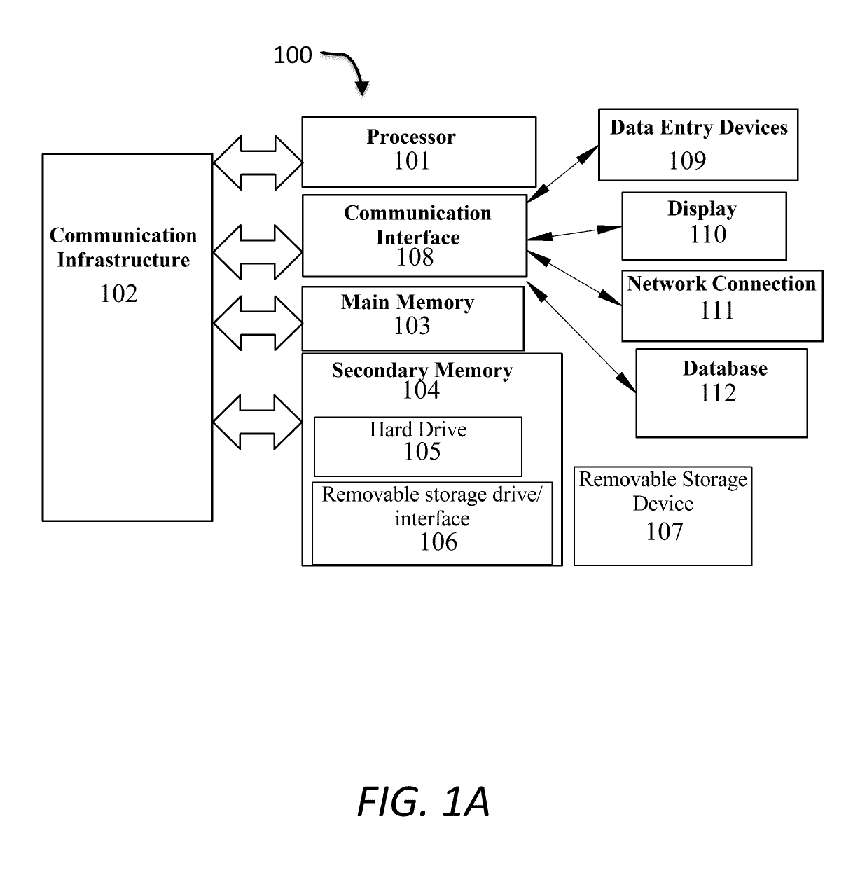

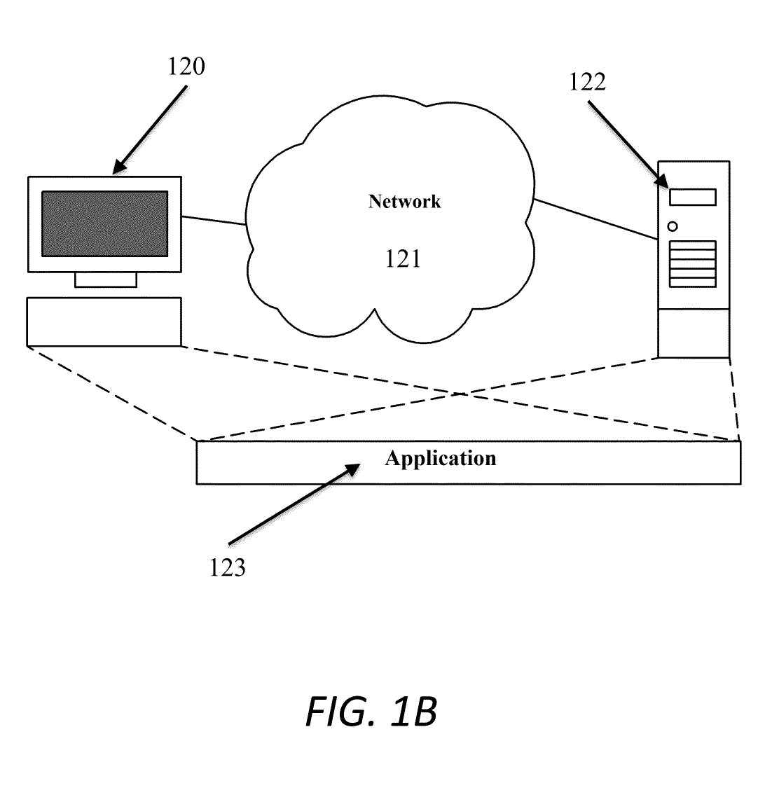

Some embodiments of the disclosed system and methods will be better understood by reference to the following comments concerning computing devices. The system and method disclosed herein will be better understood in light of the following observations concerning the computing devices that support the disclosed application, and concerning the nature of web applications in general. An exemplary computing device is illustrated by FIG. 1A. The processor 101 may be a special purpose or a general-purpose processor device. As will be appreciated by persons skilled in the relevant art, the processor device 101 may also be a single processor in a multi-core/multiprocessor system, such system operating alone, or in a cluster of computing devices operating in a cluster or server farm. The processor 101 is connected to a communication infrastructure 102, for example, a bus, message queue, network, or multi-core message-passing scheme.

The computing device also includes a main memory 103, such as random access memory (RAM), and may also include a secondary memory 104. Secondary memory 104 may include, for example, a hard disk drive 105, a removable storage drive or interface 106, connected to a removable storage unit 107, or other similar means. As will be appreciated by persons skilled in the relevant art, a removable storage unit 107 includes a computer usable storage medium having stored therein computer software and/or data. Examples of additional means creating secondary memory 104 may include a program cartridge and cartridge interface (such as that found in video game devices), a removable memory chip (such as an EPROM, or PROM) and associated socket, and other removable storage units 107 and interfaces 106 which allow software and data to be transferred from the removable storage unit 107 to the computer system.

The computing device may also include a communications interface 108. The communications interface 108 allows software and data to be transferred between the computing device and external devices. The communications interface 108 may include a modem, a network interface (such as an Ethernet card), a communications port, a PCMCIA slot and card, or other means to couple the computing device to external devices. Software and data transferred via the communications interface 108 may be in the form of signals, which may be electronic, electromagnetic, optical, or other signals capable of being received by the communications interface 108. These signals may be provided to the communications interface 108 via wire or cable, fiber optics, a phone line, a cellular phone link, and radio frequency link or other communications channels. The communications interface in the system embodiments discussed herein facilitates the coupling of the computing device with data entry devices 109, the device's display 110, and network connections, whether wired or wireless 111. It should be noted that each of these devices may be embedded in the device itself, attached via a port, or tethered using a wireless technology such as BLUETOOTH®.

Computer programs (also called computer control logic) are stored in main memory 103 and/or secondary memory 104. Computer programs may also be received via the communications interface 108. Such computer programs, when executed, enable the processor device 101 to implement the system embodiments discussed below. Accordingly, such computer programs represent controllers of the system. Where embodiments are implemented using software, the software may be stored in a computer program product and loaded into the computing device using a removable storage drive or interface 106, a hard disk drive 105, or a communications interface 108.

The computing device may also store data in database 112 accessible to the device. A database 112 is any structured collection of data. As used herein, databases can include “NoSQL” data stores, which store data in a few key-value structures such as arrays for rapid retrieval using a known set of keys (e.g. array indices). Another possibility is a relational database, which can divide the data stored into fields representing useful categories of data. As a result, a stored data record can be quickly retrieved using any known portion of the data that has been stored in that record by searching within that known datum's category within the database 112, and can be accessed by more complex queries, using languages such as Structured Query Language, which retrieve data based on limiting values passed as parameters and relationships between the data being retrieved. More specialized queries, such as image matching queries, may also be used to search some databases. A database can be created in any digital memory.

Persons skilled in the relevant art will also be aware that while any computing device must necessarily comprise facilities to perform the functions of a processor 101, a communication infrastructure 102, at least a main memory 103, and usually a communications interface 108, not all devices will necessarily house these facilities separately. For instance, in some forms of computing devices as defined above, processing 101 and memory 103 could be distributed through the same hardware device, as in a neural net, and thus the communications infrastructure 102 could be a property of the configuration of that particular hardware device. Many devices do practice a physical division of tasks as set forth above, however, and practitioners skilled in the art will understand the conceptual separation of tasks as applicable even where physical components are merged.

The systems may be deployed in a number of ways, including on a stand-alone electronic device, a set of electronic devices working together in a network, or a web application. Persons of ordinary skill in the art will recognize a web application as a particular kind of computer program system designed to function across a network, such as the Internet. A schematic illustration of a web application platform is provided in FIG. 1A. Web application platforms typically include at least one client device 120, which is an electronic device as described above. The client device 120 connects via some form of network connection to a network 121, such as the Internet. The network 121 may be any arrangement that links together electronic devices 120, 122, and includes without limitation local and international wired networks including telephone, cable, and fiber-optic networks, wireless networks that exchange information using signals of electromagnetic radiation, including cellular communication and data networks, and any combination of those wired and wireless networks. Also connected to the network 121 is at least one server 122, which is also an electronic device as described above, or a set of electronic devices that communicate with each other and work in concert by local or network connections. Of course, practitioners of ordinary skill in the relevant art will recognize that a web application can, and typically does, run on several servers 122 and a vast and continuously changing population of client devices 120. Computer programs on both the client device 120 and the server 122 configure both devices to perform the functions required of the web application 123. Web applications 123 can be designed so that the bulk of their processing tasks are accomplished by the server 122, as configured to perform those tasks by its web application program, or alternatively by the client device 120. Some web applications 123 are designed so that the client device 120 solely displays content that is sent to it by the server 122, and the server 122 performs all of the processing, business logic, and data storage tasks. Such “thin client” web applications are sometimes referred to as “cloud” applications, because essentially all computing tasks are performed by a set of servers 122 and data centers visible to the client only as a single opaque entity, often represented on diagrams as a cloud. However, the web application must inherently involve some programming on each device.

Many electronic devices, as defined herein, come equipped with a specialized program, known as a web browser, which enables them to act as a client device 120 at least for the purposes of receiving and displaying data output by the server 122 without any additional programming. Web browsers can also act as a platform to run so much of a web application as is being performed by the client device 120, and it is a common practice to write the portion of a web application calculated to run on the client device 120 to be operated entirely by a web browser. Such browser-executed programs are referred to herein as “client-side programs,” and frequently are loaded onto the browser from the server 122 at the same time as the other content the server 122 sends to the browser. However, it is also possible to write programs that do not run on web browsers but still cause an electronic device to operate as a web application client 120. Thus, as a general matter, web applications 123 require some computer program configuration of both the client device (or devices) 120 and the server 122. The computer program that comprises the web application component on either electronic device's system FIG. 1A configures that device's processor 200 to perform the portion of the overall web application's functions that the programmer chooses to assign to that device. Persons of ordinary skill in the art will appreciate that the programming tasks assigned to one device may overlap with those assigned to another, in the interests of robustness, flexibility, or performance. Furthermore, although the best known example of a web application as used herein uses the kind of hypertext markup language protocol popularized by the World Wide Web, practitioners of ordinary skill in the art will be aware of other network communication protocols, such as File Transfer Protocol, that also support web applications as defined herein.

Embodiments of the present invention are directed to a system and method for providing reliable, adaptive, and objective skill-based testing. In some embodiments, the system is a cloud-based technical assessment platform that presents technical professionals (“test-takers”) with a live server environment where they can demonstrate their technical skills. The invention includes an adaptive test that is dynamically generated from a database of possible variables. This ensure that each test is unique and tailored to the test-sponsor's requirements

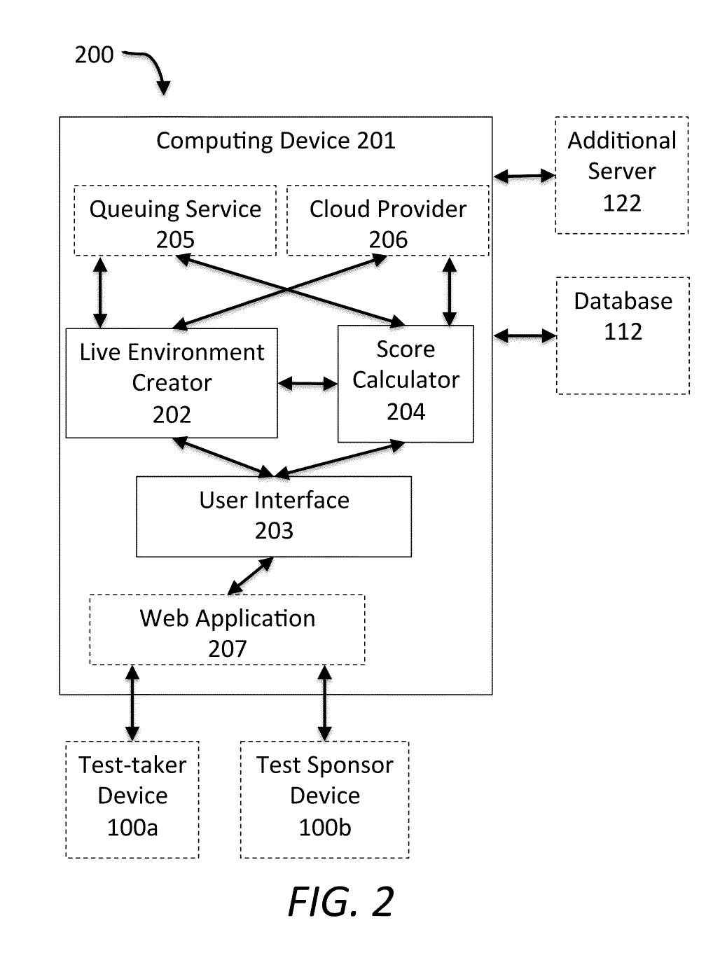

FIG. 2 depicts a system for electronic skill-based testing. As an overview the system includes a computing device 201. Executing on the computing device 201 is a set of algorithmic steps that may be conceptually described as creating a live environment creator 202, a user interface 203, and a score calculator 204. The organization of tasks into those three components solely reflects a categorization of the tasks to be performed, and does not dictate the architecture of particular implementations of the system 200. For instance, in some embodiments of the system 200, the steps performed are executed by various objects in an object-oriented language, but the objects divide the tasks in a different manner than the above division. In other embodiments, the algorithmic steps exist as a set of instructions in a non-object oriented language, with no explicit separation of responsibility for steps into distinct components at all. Persons skilled in the art will recognize the existence of a broad variety of programming approaches that could cause the computing device 201 to perform the algorithmic steps.

In some embodiments, the system 200 is designed to evaluate the skills of a test-taker. In one embodiment, a test-taker includes, but is not limited to a person, whether a technical professional or not, who takes any skills assessment as described by this invention. A test-taker may be a prospective employee. In an embodiment, a test-sponsor is any person or organization with an interest in assessing the skills of a test-taker. In some embodiments, the test-taker may also be the test-sponsor.

Referring to FIG. 2 in more detail, the system 200 includes a computing device 201. In some embodiments, the computing device 201 is a computing device 100 as disclosed above in reference to FIG. 1A. In one embodiment, the computing device 201 is a server 122 as disclosed above in reference to FIG. 1B. The computing device 201 may communicate with one or more additional servers 122. The computing device 201 and the one or more additional servers 122 may coordinate their processing to emulate the activity of a single server 122 as described above in reference to FIG. 1B. The computing device 201 and the one or more additional servers 122 may divide tasks up heterogeneously between devices; for instance, the computing device 201 may delegate the tasks of the user interface 203 to an additional server 122. In some embodiments, the computing device 201 functions as a client device 120 as disclosed above in reference to FIG. 1B. In some embodiments, the computing device 201 functions as a stand-alone device, running all the processes locally and communicating with a test-taker via a communications interface 108, as disclosed above in reference to FIG. 1A.

The computing device 201 in some embodiments communicates with a database 112, which may be a database 112 as disclosed above in reference to FIG. 1A. In some embodiments, the computing device 201 hosts a queuing service 205. In some embodiments, the queuing service 205 queues jobs for the computing device 201 and waits for responses. The queuing service 205 may create background jobs. The queuing service 205 may place and manage such jobs in multiple queues. The queuing service 205 may process such jobs. The queuing service 205 in some embodiments starts and stops processes making up parts of the disclosed method. The queuing service 205 may be distributed across several servers. In some embodiments, a cloud provider 206 executes on the computing device. In one embodiment, the cloud provider 206 provides the servers, data processing, and storage for the other components and for the queuing service 205. The cloud provider 206 may also provide virtual servers to create the live environment in some embodiments.

A live environment creator 202 executes on the computing device 201. The live environment creator 202 in some embodiments is a computer program as described above in reference to FIG. 1A. In some embodiments, the live environment creator 202 creates a live environment. A live environment may be a computing device 100 as described above in reference to FIG. 1A, configured to create a machine of the type for which the test-taker is attempting to demonstrate aptitude. For example, a live environment may be a live server, such as an Apache webserver. The live environment may be a MySQL server. The live environment may be a mail server. The live environment may be a relational database management system. The live environment may be an operating system. The live environment may be an application running on an operating system. The live environment may be a network of computing devices. The live environment may be a web application, as described above by reference to FIG. 1B.

The live environment may be created on the computing device 201. The live environment may be created on the one or more additional servers 122. The live environment may be distributed across several servers 122. The live environment may be created on a client device 120a used by the test-taker. The live environment may be distributed between one or more servers 122 and one or more client devices 120a. The live environment may be created on a virtual machine. In some embodiments, the live environment is a non-virtual live environment, which does not include a virtual machine and is not created on a virtual machine.

In some embodiments, the live environment creator 202 creates a live environment that has an issue. An issue may be any factor that prevents the live environment from performing the task for which it is designed. In one embodiment, an issue is a misconfiguration; for example, where the live environment is an Apache server, the issue may be a misconfiguration of that server. The issue may be the absence of a software module; for example, where the live environment is an operating system, the issue may be the absence of a driver. The issue may be an incorrect software module, such as a driver for the wrong hardware element. The issue may be a defect or “bug” in a software module. For example, where the live environment is an operating system, it could have a driver that contains a bug, which must be fixed (using the driver source code) before the driver, and thus the operating system, works properly. The issue could be an improperly installed hardware element. The issue could be an incorrectly wired circuit. The issue could be an incorrectly grounded circuit. The issue could be a machine that has been switched off; for example, where the live environment is a network of servers, the issue could be a downed server that must be restarted. The issue could be a malicious program such as a virus or worm that must be removed from the live environment.

Some embodiments of the system 200 include a user interface 203. The user interface 203 in some embodiments is a computer program as described above in reference to FIG. 1A. In one embodiment, the user interface 203 provides data to the test taker concerning the skill-based examination. The user interface 203 may provide data to the test taker informing the test-taker of the state of the live environment. In some embodiments, the user interface 203 communicates with a display used by the test-taker. The user interface 203 may also receive data from the test-taker via a communications interface 108 as described above in reference to FIG. 1A. The user interface 203 may also communicate with the test-sponsor. The user interface 203 may provide data to the test-sponsor. The user interface 203 may receive data from the test-sponsor.

In some embodiments, the user interface 203 communicates with the test-taker via a web application 206. The web application 207 may be a web application 123 as described above in reference to FIG. 1B. In particular, when the computing device 201 is a server, the web application 207 may relay data provided by the user interface 203 to the test-taker via the test-taker client 120a. The web application 207 may receive data from the test-taker via the test-taker client 120a. The web application 207 may relay data provided by the user interface 203 to the test-sponsor via the test-sponsor client 120b. The web application 207 may receive data from the test-sponsor via the test-sponsor client 120b.

In some embodiments, the system 200 includes a score calculator 204. The score calculator 204 in some embodiments is a computer program as described above in reference to FIG. 1A. In an embodiment, the score calculator 204 communicates with the live environment to determine information concerning the skills-based test. In another embodiment, the score calculator 204 communicates with the user interface 203 to provide data concerning the score to the user interface 203.

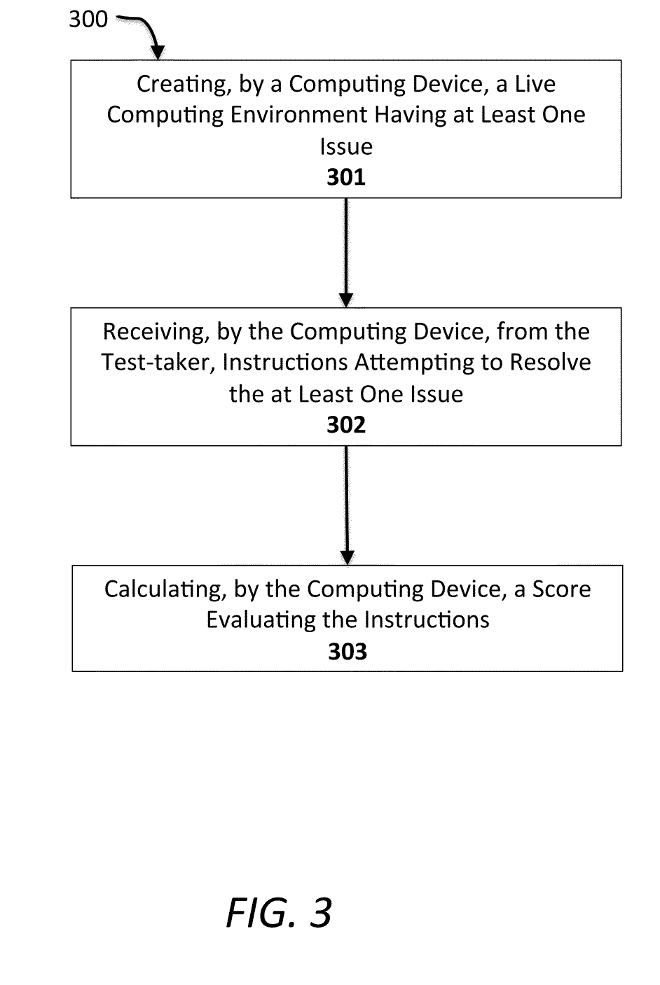

FIG. 3 illustrates some embodiments of a method 300 for electronic skill-based testing. The method 300 includes creating, by a computing device, a live computing environment having at least one issue (301). The method 300 further includes receiving, by the computing device, from the test-taker, instructions attempting to resolve the issue (302). The method includes calculating, by the computing device, a score evaluating the instructions (303).

Referring to FIG. 3 in greater detail, and by reference to FIG. 2, the method 300 includes creating, by a computing device, a live computing environment having at least one issue (301). In some embodiments, the live environment creator 202 creates the live computing environment by providing a live computing environment that is functioning correctly, and introducing an issue into the live computing environment. For example, the live environment creator 202 may install a functioning Apache server on a server 122 coupled to the computing device 201, and then change its configuration so that one or more elements are misconfigured. The live environment creator 202 may install an operating system on a server 122, and then remove one or more software modules, such as drivers, from the installed system. The live environment creator 202 may install an operating system on a server and replace the correct driver for a hardware element with an incorrect driver. The live environment creator 202 may replace a software module with a software module containing a bug. The live environment creator 202 may introduce a malicious program into an initially functioning live computing environment.

In other embodiments, the live environment creator 202 creates an environment already designed to have at least one issue. For example, the live environment creator 202 may install an operating system that is missing some drivers. The live environment creator 202 may fail to perform one or more configuration steps when installing an Apache server. The live environment creator 202 may install a defective software module as part of the initial installation of the live computing environment. The live environment creator 202 may install an incorrect software module as part of the initial installation of the live computing environment. The live environment creator 202 may install a malicious application as part of the initial installation.

In some embodiments, the computing device 201 maintains, in memory accessible to the computing device 201, a set of examination scenarios, each scenario including instructions to create a live computing environment having at least one issue; the live environment creator 202 selects a scenario from the set of examination scenarios and executes the instructions of which the scenario is made up. For example, an examination scenario may include an installation package for an Apache server, including an installation program missing certain configuration steps; the installation program is a series of instructions to modify the memory of a server 122 as further instructed by the contents of the package. Another scenario may include an installation program and package for an operating system, in which the package lacks one or more drivers. In an embodiment, a scenario may include a script that first directs the live environment creator 202 to run a functioning installation program and package, and after completion of the installation further instructs the live environment creator 202 to introduce an issue into the installed live computing environment, as described above.

In a related embodiment, the scenarios are grouped by difficulty level, and the live environment creator 202 selects a scenario by selecting a test-taker difficulty level and selecting a scenario from a group corresponding to that test-taker difficulty level. The test-sponsor may input data into the system 200 assigning a difficulty level to each scenario. In one embodiment, the score calculator 204 maintains records of various test-takers' performance on a particular scenario, and modifies its difficulty level according to those records; for example, if the average test-taker struggles to resolve the issues presented by a particular scenario that has hitherto been classified as easy, the score calculator 204 may direct the computing device 201 to increase the difficulty level associated with that scenario. In another embodiment, the live environment creator 202 selects the test-taker difficulty level by maintaining, in memory accessible to the computing device, data reflecting past performance of the test taker, and determining, using that data, a test-taker difficulty level for the test-taker. For example, and without limitation, the score calculator 204 may maintain average scores that the test-taker has achieved at each difficulty level at which the test-taker has attempted to resolve a scenario. The live environment creator 202 may select a difficulty level at which the test-taker has on average passed some threshold of success in past attempts. The threshold may be a minimum passing percentage. The threshold may be a percentile of other test-takers' scores at that difficulty level; for instance, the test-taker may have to be in the 75^{th} percentile or above to be assigned the difficulty level.

In some embodiments, the live environment creator 202 selects the scenario to use by randomly selecting a scenario from the set of scenarios. In one embodiment, the random selection is accomplished by assigning an index to each scenario, where an index is defined as a unique cardinal number assigned to that scenario, generating a random number that is a member of the set of all the assigned index numbers, and selecting the scenario to for which the random number is the corresponding index. In other embodiments, the random selection involves randomly selecting a scenario from a group of scenarios at a particular difficulty level. Thus, for instance, the live environment creator 202 may choose a test-taker difficulty level, as set forth above, generate a random number that is a member of the set of indices assigned to the scenarios in the group corresponding to the test-taker difficulty level, and select the scenario corresponding to the random number.

In some embodiments, the live environment creator 202 creates the live computing environment by combining two or more scenarios. For instance, the live environment creator 202 may select one scenario that involves a misconfigured Apache server and another scenario that involves the introduction of a virus, and create as the live computing environment a misconfigured Apache server with a virus. In some embodiments, the live environment creator 202 creates the live environment immediately before providing access to the test-taker. In some embodiments, each skill assessment is generated dynamically for each test-taker from a list of variables and information included in memory accessible to the computing device 201.

The method 300 further includes receiving, by the computing device, from the test-taker, instructions attempting to resolve the issue (302). In some embodiments, the user interface 203 provides access for the test-taker to the live computing environment. In some embodiments, the user interface 203 sends the test-taker instructions on how to log into the test environment. The instructions may inform the test-taker of the required tasks for the skills assessment. In some embodiments the instructions sent to the test-taker are general cases that could be typically encountered in the workplace. In other embodiments, the instructions are more specific in identifying the issues to resolve. In still other embodiments, the test-taker is left to determine what the issues are that need resolution by troubleshooting and testing the functioning of the live computing environment. Where the live computing environment is on a computing device that is being used directly by the test-taker, the user interface 203 may provide the test-taker access to the live computing environment via a communications interface 108 as described above in reference to FIG. 1A. Where the live computing environment is on a server 122 remote from the test-taker, the user interface 203 may provide the test-taker access to the live computing environment by providing the test-taker with the means to log on remotely from the test-taker's client machine 120a.

In some embodiments, the user interface 203 records inputs of the test taker. In one embodiment, the inputs are the keystrokes of the test taker. In another embodiment, inputs include the mouse movements of the test-taker. Inputs may include audio input. Inputs may include video input. In some embodiments, the inputs are organized into groupings that render their purpose intelligible. For instance, a series of keystrokes may be saved as text in string variables, enabling a later observer to read the text that was entered. In some embodiments, the user interface 203 records steps performed by the test-taker. Steps may include changes the test-taker made to the live computing environment. In some embodiments, the steps may include all changes made by to the live computing environment by the test-taker, including changes the test-taker removed prior to the end of the skills assessment; for instance, when the test-taker enters text and then deletes it, the entrance of the text and its subsequent deletion are recorded as steps. In other embodiments, the steps may include only changes to the live computing environment that the test-taker left in place at the end of the skills assessment; for instance, when the test-taker enters text and then deletes it, the entrance of the text, which would initially have been recorded as a step, is removed from the set of recorded steps, and no step is added for the deletion. In some embodiments, the user interface 203 records the time spent by the test taker during the skills assessment. In some embodiments, the user interface 203 records the time spent by the test taker to resolve each issue. In some embodiments, the user interface 203 records the time spent by the test taker to take each step. In some embodiments, the computing device 201 maintains a time limit, and when the total time in the skills assessment reaches that limit, the user interface 203 stops letting the test-taker enter instructions.

The method includes calculating, by the computing device, a score evaluating the instructions (303). In some embodiments, the score calculator 204 analyzes the live computing environment and determines that the test-taker resolved the at least one issue. In one embodiment, the score calculator 204 determines the score on a pass-fail basis; for instance, if the at least one issue is completely resolved, the score calculator 204 gives the test-taker a passing score, and if the at least one issue is not completely resolved, the score calculator gives the test-taker a failing score. In another embodiment, the score calculator 204 gives the test-taker a percentage score. In yet another embodiment, the score calculator 204 gives the test-taker a cumulative score with no upper limit.

The score calculator 204 may increase or decrease the score depending on other measures of the test-taker's performance. In one embodiment, the score calculator 204 assesses the robustness of a resolution the test-taker provided for the issue. The score calculator may determine a level of precision at which the resolution fails; for instance, if the resolution functions effectively for a wide range of numerical values the test-taker may receive a higher score than if the resolution functions effectively only for a narrow range of numerical values. The score calculator may determine a level of volume at which the resolution fails. Thus, for example, if an Apache server, as repaired by the test-taker, can respond effectively to larger numbers of simultaneous requests from client devices, the score calculator 204 may assign the test-taker a higher score than if the Apache server slows down or crashes at relatively lower volumes. In some embodiments, the score calculator 204 determines how long the live computing environment, as resolved by the test-taker, takes to perform a task, as a function of a parameter of the task; for instance, the score calculator 204 might assess the “big O” efficiency of a coded solution the test-taker provided.

In some embodiments, the score calculator 204 ranks the score calculated for the test-taker relative to the score of at least one additional test-taker. For instance, the score calculator 204 may express the score of the test-taker as a percentile compared to the scores of other test-takers. The score calculator 204 may scale the score of the test-taker using statistical data concerning the scores of other test-takers. In some embodiments, the score calculator 204 assigns a higher score if the test-taker resolved the issues presented by a scenario at a higher level of difficulty. In some embodiments, the score calculator 204 modifies the score based on the amount of time the test-taker took to resolve a particular issue; for instance, if the test-taker resolved the issue more quickly, the score calculator 204 may give the test-taker a higher score. In some embodiments, the score calculator 204 modifies the score based on the volume of input the test-taker required to resolve an issue; for example, if the test-taker had to engage in a larger volume of inputs to resolve an issue, the test-taker may get a lower score. The score calculator 204 might modify the score based on the number of steps the test taker required to solve an issue; if, as an example, the test-taker had to try many different steps before finding the right one, the test-taker may have his or her score lowered.

In some embodiments, the score calculator 204 gives partial credit to a test-taker who failed to resolve all of the issues that were present in a live environment. In one embodiment, the score calculator 204 maintains, in memory accessible to the computing device, a set of model instructions that together resolve the issue, compares the instructions entered by the test-taker to the model instructions, and increases the score for each instruction entered by the test-taker that matches a model instruction. In some embodiments, where the live computing environment has more than one issue for the test-taker to resolve, the score calculator 204 increases the score of the test-taker for each issue that the test-taker resolves completely.

In some embodiments, the user interface 203 provides data concerning the score to a test-sponsor. In one embodiment, the user interface 203 provides the score to the test-sponsor. In another embodiment, the user interface 203 provides the steps taken by the test-taker to the sponsor. In another embodiment, the user interface 203 accepts modifications to the score from the test-sponsor. For instance, the test-sponsor might increase or decrease the score based upon factors the test-sponsor is aware of; for instance, if there is a fire alarm during the test, the test-sponsor might increase the test-taker's score to reflect reduced time that the test-taker had to resolve the issues in the live environment. In some embodiments, the test-sponsor adds comments to the score.

It will be understood that the system and method may be embodied in other specific forms without departing from the spirit or central characteristics thereof. The present examples and embodiments, therefore, are to be considered in all respects as illustrative and not restrictive, and the system method is not to be limited to the details given herein.

What is claimed is:

1. A method for electronic skill-based testing, the method comprising:
creating, by a computing device, a live computing environment having at least one issue;
receiving, by the computing device, from the test-taker, instructions attempting to resolve the at least one issue; and
calculating, by the computing device, a score evaluating the instructions.

2. A method according to claim 1, wherein creating the live computing environment further comprises:
providing a live computing environment that is functioning correctly; and
introducing at least one issue into the live computing environment.

3. A method according to claim 1, wherein creating the live computing environment further comprises:
maintaining, in memory accessible to the computing device, a set of examination scenarios, each scenario comprising instructions to create a live computing environment having at least one issue;
selecting a scenario from the set of examination scenarios; and
executing the instructions of which the scenario is comprised.

4. A method according to claim 3, wherein the scenarios are grouped by difficulty level, and wherein selecting comprises selecting a test-taker difficulty level and selecting a scenario from a group corresponding to that test-taker difficulty level.

5. A method according to claim 4, wherein selecting the test-taker difficulty level further comprises:
maintaining, in memory accessible to the computing device, data reflecting past performance of the test-taker; and
determining, using that data, a test-taker difficulty level for the test taker.

6. A method according to claim 3, wherein selecting further comprises randomly selecting a scenario from the set of scenarios.

7. A method according to claim 1, wherein creating further comprises creating the live environment immediately before providing access to the test-taker.

8. A method according to claim 1, wherein receiving further comprises recording the inputs of the test-taker.

9. A method according to claim 1, wherein receiving further comprises recording the steps performed by the test taker.

10. A method according to claim 1, wherein receiving further comprises recording the time spent by the test-taker.

11. A method according to claim 1, wherein calculating further comprises analyzing the live computing environment and determining that the test-taker resolved the at least one issue.

12. A method according to claim 1, wherein calculating further comprises assessing the robustness of a resolution the test-taker provided for the issue.

13. A method according to claim 1, wherein calculating further comprises determining how long the live computing environment, as resolved by the test-taker, takes to perform a task, as a function of a parameter of the task.

14. A method according to claim 1, wherein calculating further comprises ranking the score calculated for the test-taker relative to the score of at least one additional test-taker.

15. A method according to claim 1, further comprising:
maintaining, in memory accessible to the computing device, a set of model instructions that together resolve the issue;
comparing the instructions entered by the test-taker to the model instructions; and
increasing the score for each instruction entered by the test-taker that matches a model instruction.

16. A method according to claim 1, further comprising providing data concerning the score to a test-sponsor.

17. A method according to claim 16, further comprising accepting, by the computing device, modifications to the score from the test-sponsor.

18. A system for electronic skill-based testing, the system comprising:
a computing device;
a live environment creator, executing on the computing device and creating a live computing environment having at least one issue;
a user interface, executing on the computing device and receiving, from the test-taker, instructions attempting to resolve the issue; and
a score calculator, executing on the computing device and calculating a score evaluating the instructions.
